(19) United States
(12) Patent Application Publication
(10) Pub. No.: US 2016/0110514 A1
(43) Pub. Date: Apr. 21, 2016

(54) PERSONAL HEALTHCARE DEVICE, SMART DEVICE, AND METHOD OF PROVIDING HEALTHCARE SERVICE FOR PREGNANT WOMEN USING THE SAME

(71) Applicant: ELECTRONICS AND TELECOMMUNICATIONS RESEARCH INSTITUTE, Daejeon (KR)

(72) Inventor: Won Ick JANG, Daejeon (KR)

(21) Appl. No.: 14/918,093

(22) Filed: Oct. 20, 2015

(30) Foreign Application Priority Data
Oct. 20, 2014 (KR) 10-2014-0141966
Aug. 4, 2015 (KR) 10-2015-0110185

(51) Int. Cl. G06F 19/00

(52) U.S. Cl. CPC G06F 19/3418; G06F 19/322

(57) ABSTRACT

The present disclosure relates to a personal healthcare device (PHD), a smart device, and a method of providing pregnancy care services using the same so as to constantly monitor health conditions of the pregnant women and babies in utero, thereby preventing dangers in advance, such as pregnancy toxemia, abortion, fetal deformity, etc.

### CROSS-REFERENCE TO RELATED APPLICATION(S)

This application claims the benefit under 35 U.S.C. §119(a) of Korean Patent Application Nos. 10-2014-0141966, filed on Oct. 20, 2014, and 10-2015-0110185, filed on Aug. 4, 2015, in the Korean Intellectual Property Office, the entire disclosures of which are incorporated herein by references for all purposes.

### BACKGROUND

1. Field

The following description relates to a technology of healthcare devices and remote healthcare services.

2. Description of the Related Art

Ubiquitous healthcare service technology is being actively developed, which provides personal health management and medical services, such as prevention, diagnosis, treatment, prescription, daily management, in a more efficient and convenient manner. Particularly, as demands on healthcare services are increasing due to low birth rates and aging population, the healthcare and medical services paradigm are switching from one of treatment to that of prevention. The trend is that healthy people as well as patients pay great attention to their health, thus rapidly increasing the potential demand for the service. In order to respond proactively to issues such as population decline, encouraging higher birthrates, providing healthcare to mothers and babies in utero, constant monitoring is required.

### SUMMARY

The following description relates to a personal device, a smart device, and a method of providing healthcare services for pregnant women (hereinafter referred to as ‘pregnancy care services’) so as to constantly monitor and manage health conditions of pregnant women and babies in utero based on ubiquitous information technology (IT) that enables anyone to safely and freely monitor their health conditions anytime and anywhere, thereby preventing dangers in advance, such as pregnancy toxemia, abortion, fetal deformity, and premature birth.

In one general aspect, a personal healthcare device (PHD) includes: a measurer to measure health conditions of a pregnant woman so as to gather personal health information from a pregnant woman; a processor to, according to PHD standards defined for each PHD and Bluetooth healthcare device profiles for Bluetooth communications, process personal health information, and control a connection to a smart device, which is based on a mobile operating system (OS), as well as an information transmission thereto or reception therefrom; and a communicator to transmit the personal health information to the smart device by using the PHD standards and the Bluetooth healthcare device profiles.

The PHD may be a urine analyzer, and the processor may control the connection to the smart device and the information transmission thereto or reception therefrom according to IEEE 11073-10422 PHD standards. The PHD may be a sphygmomanometer, and the processor may control the connection to the smart device, as well as the information transmission thereto or reception therefrom according to IEEE 11073-10407 PHD standards.

The processor may analyze the personal health information by, based on hues, saturation, and brightness, distinguishing a color of a urine reagent strip, which is acquired by immersing the urine reagent strip in a sample of urine of the pregnant woman. The communicator may test a transmission of a PHD standard protocol between the PHD and the smart device.

The personal health information may include measurement data including bilirubin, glucose, ketones, leukocyte esterase, nitrite, pH, gravity, occult blood, protein, urobilinogen. The personal health information may be distinguished into at least one of numeric data shown in number, enumeration data showing events, and waveform data according to types of measurement data measured by the PHD.

In another general aspect, a smart device includes: a memory in which a mobile operating system (OS) is stored; a processor to execute a mobile application based on a mobile OS and control a connection to a personal healthcare device (PHD), in which PHD standards are defined, as well as data transmission thereto or reception therefrom; a first communicator to receive gathered personal health information from a pregnant woman through at least one PHD by using PHD standards and Bluetooth healthcare device profiles (HDPs); and a second communicator to transmit, to a healthcare service server, which provides healthcare services for a pregnant woman (pregnancy care services), the personal health information received from the first communicator.

The personal health information may include a urine analysis result acquired by a urine analyzer, to which IEEE 11073-10422 PHD standards are applied. The personal health information may include blood pressure data acquired from a sphygmomanometer, to which IEEE 11073-10407 PHD standards are applied.

In yet another general aspect, a method of providing healthcare services for a pregnant woman (pregnancy care services) includes: measuring health conditions of a pregnant woman so as to gather personal health information of the pregnant woman through at least one PHD, where PHD standards are defined; receiving, by a smart device based on a mobile OS, the personal health information from at least one PHD by using PHD standards and Bluetooth healthcare device profiles (HDPs); transmitting, by the smart device, the personal health information to a server; and managing, by the server, the health conditions of the pregnant woman through a service platform by using the personal health information.

The receiving of the personal health information from the at least one PHD may include: executing a mobile application of the smart device; displaying a list with at least one PHD that is connectable in response to the execution of the mobile application, receiving, from a user, a selection of the PHD to be connected, and setting a connection for a use of Bluetooth healthcare device profiles; establishing a connection to the selected PHD; and receiving the gathered personal health information from the connected PHD according to the PHD standards and the Bluetooth healthcare device profiles (HDPs).

The service platform may include a monitoring center, a data server, and a hospital information system (HIS); and the managing of the health conditions of the pregnant woman may include: storing, at the data server, a healthcare history comprising the personal health information of the pregnant woman; monitoring, by the monitoring center, the healthcare history of the pregnant woman and reporting the monitored results to the HIS; and providing, by the HIS, the monitored results, and in response to a detection of any concerns of the pregnant woman's conditions, notifying the pregnant woman of the concerns.

The managing of the health conditions of the pregnant woman may include storing, by the server, the received personal health information, automatically analyzing the stored personal health information, and determining whether the pregnant woman has bad health conditions.

The personal health information may include: a urine analysis result acquired by a urine analyzer, to which IEEE 11073-10422 PHD standards are applied; and blood pressure data acquired from a sphygmomanometer, to which IEEE 11073-10407 PHD standards are applied. The managing of the health conditions of the pregnant woman may include managing the health conditions of the pregnant woman by using a urine analysis result and blood pressure data, which are received from a urine analyzer and a sphygmomanometer through the smart device.

The transmitting of the personal health information to the server may include: transmitting, by the smart device, the personal health information to a gateway; and transmitting, by the gateway, the personal health information to the server.

The service platform may include a monitoring center, a data server, and a hospital information system (HIS); and the method may further include: prior to a provision of pregnancy care services, determining, by the monitoring center, whether a woman is pregnant, and in response to the determination that the woman is indeed pregnant, sending a request to the data server so that the pregnant woman is subscribed to the pregnancy care services; checking and accepting, by the data server, whether the pregnant woman is subscribed to the pregnancy care services, registering the pregnant woman so that the pregnant woman uses the pregnancy care services, and registering the healthcare service provided by a HIS of a participating hospital; and in response to completion of the healthcare service registration, providing the pregnant woman with a device for the healthcare service including a PHD through the monitoring center.

Other features and aspects may be apparent from the following detailed description, the drawings, and the claims.

### BRIEF DESCRIPTION OF THE DRAWINGS

FIG. 1 is a diagram illustrating an example of pregnancy care service system according to an exemplary embodiment.

FIG. 2 is a diagram illustrating a personal healthcare device (hereinafter referred to as ‘PHD’) according to an exemplary embodiment.

FIG. 3 is a diagram illustrating a smart device according to an exemplary embodiment.

FIG. 4 is a diagram illustrating object instances of a urine analyzer according to an exemplary embodiment.

FIG. 5 is a flowchart illustrating a processing of measurement information by a smart device according to an exemplary embodiment.

FIG. 6 is a diagram illustrating a screen onto which the data received from a PHD has been displayed by a smart device according to an exemplary embodiment.

FIGS. 7A and 7B are diagrams illustrating a correlation of protein and glucose by a urine analyzer and an ADVIA 1650 analyzer according to an exemplary embodiment.

FIG. 8 is a diagram illustrating a platform environment for providing pregnancy care services according to an exemplary embodiment.

FIGS. 9A and 9B are flowcharts illustrating processes of pregnancy care services according to an exemplary embodiment.

FIG. 10 is a diagram illustrating lists of diseases that may be discovered using a urine analyzer according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

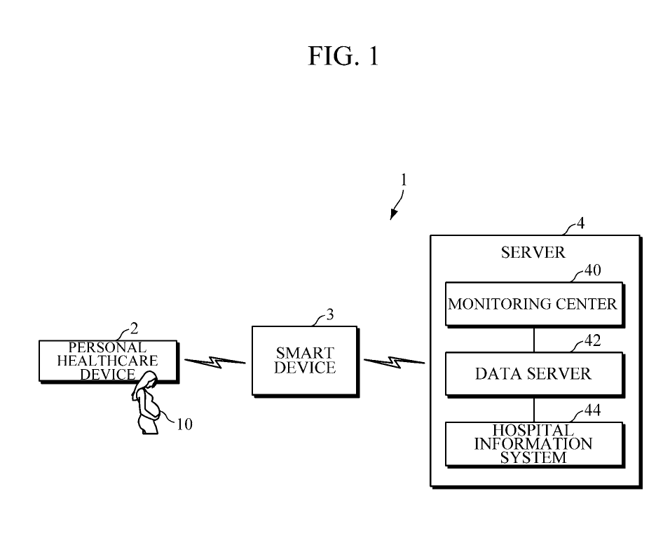

FIG. 1 is a diagram illustrating an example of a pregnancy care service system according to an exemplary embodiment.

Referring to FIG. 1, a system 1 of providing pregnancy care services includes a personal healthcare device 2 (hereinafter referred to as ‘PHD’), a smart device 3, and a server 4.

The PHD 2, which has standards for each type of PHD, measures the health conditions of a pregnant woman 10 so as to compile her personal health information, and transmits the personal health information to a smart device 3 that is based on a mobile operating system (hereinafter referred to as an ‘OS’). The smart device 3 receives the personal health information from the PHD 2 by using PHD standards and Bluetooth® healthcare device profiles (hereinafter referred to as ‘Bluetooth® HDPs’), and transmits the received personal health information to the server 4. The server 4 provides, to the pregnant woman 10, pregnancy care services based on the received personal health information. Through the pregnancy care services, the health conditions of both the pregnant woman 10 and the baby in utero may be monitored and managed constantly during the entire gestation period.

Said personal health information of the pregnant woman and baby includes content for monitoring the health conditions of the pregnant woman 10, such as pregnancy toxemia, diabetes, anemia, etc., as well as for monitoring the conditions of her baby in utero, such as abortion, fetal deformity, and premature birth. The personal health information may be urine data acquired by a urine analyzer and blood pressure data acquired from a sphygmomanometer.

For example, as stated earlier, the pregnancy care services measure the health conditions of a pregnant woman 10 so as to compile her personal health information, such as urine data and blood data, by using the PHD 2, e.g., a urine analyzer and a sphygmomanometer. Said personal health information is transmitted to a server 4 by passing through user access networks by the smart device 3. The server 4 determines the health condition of the pregnant woman 10 by constantly monitoring and managing the personal health information. When an abnormality in her condition is detected, the server 4 warns the pregnant woman 10 or recommends the pregnant woman 10 visit a hospital immediately, thus preventing in advance any problems the pregnant woman 10 and her baby in utero may encounter, e.g., pregnancy toxemia, abortion, fetal deformity, and premature birth.

The PHD 2 is a device, in which IT (information technology), BT (bio technology), NT (nano technology), etc., have all been converged, and which includes all kinds of measurement devices that check the health conditions of pregnant women, such as an exercise monitor, a heart rate monitor, a blood glucose monitor, a weighing scale, a thermometer, an electrocardiograph (EGC), etc. Moreover, the PHD 2 may be a urine analyzer that is capable of collecting and analyzing urine data, and a sphygmomanometer that measures blood pressure. The PHD 2 is portable, and may thus be carried around by the pregnant woman 10 to be used anytime and anywhere. The PHD 2 uses the IEEE 11073 PHD standards and the Bluetooth® HDPs for the exchange of personal health information with the smart device 3. Hereinafter, the IEEE 11073 PHD standards and the Bluetooth® HDPs are to be specifically described.

The International Organization for Standardization (ISO) is in the process of standardizing IT-applied PHD so as to minimize the interference or efforts of an information user in accessing personal health information. The ISO/IEEE defines PHD standards by using a series of 11073 standards. Particularly, the IEEE 11073 PHD working group (WG) has been carrying out the task of establishing standards for each PHD based on the optimized exchange protocol (OXP) IEEE 11073-20601 so as to make possible the proliferation of PHDs, guaranteeing interoperability between the PHD, which is the agent, and the managing device.

Since IEEE 11073-20601 is used in various types of PHDs and is thus abstract in its concept, the process of device-specific specialization (104zz) has been under way, allowing for the application thereof to each relevant device according to the PHD characteristics. All PHD standardizations stem from 11073-20601, but because the characteristics of each device were considered and applied, an understanding of each standard is required. For example, IEEE 11073-10422 PHD standards are applied to a urine analyzer, and IEEE 11073-10407 PHD standards are applied to a sphygmomanometer. The IEEE 11073 PHD standards do not define a physical transmission method but assumes that Bluetooth®, HDP, USB, ZigBee, etc., which are currently implementable, may all be used.

The Bluetooth® HDP is a profile which defines and implements the Bluetooth® connection and communications between data collecting devices, such as PHD and smart devices. The HDP provides two types of channels: a control channel and a data channel. The control channel is used to negotiate the data channel parameters and set the data channels. The data channel is used to transmit the 11073-104zz data and is divided again into what is called a reliable data channel for non-continuous data and a streaming data channel for continuous data. First, the connection is established using the control channel, and then the connection of one or more data channels is established. Once the connection of the two channels has been established, data is received and transmitted through either the reliable data channel or the streaming data channel depending on the characteristics of the data.

The smart device 3 is a mobile terminal that a user is capable of carrying, including all terminals that is capable of communicating with the PHD 2 and the server 4. The smart device 3 is, for example, a smartphone. The smart device 3 includes a mobile OS installed therein, based on which the smart device 3 collects personal health information from the PHD 2. The mobile OS is an OS that is executable in the smart device 3, such as Google's Android, Apple's iOS, Microsoft's Windows Mobile, etc.

According to an exemplary embodiment, the server 4 includes a monitoring center 40, a data server 42, and a hospital information system (HIS) 44. In the data server 4, healthcare history is stored, which includes the personal health information of the pregnant woman 10. In the monitoring center 40, a local manager and a global manager give healthcare advice and consultation to the pregnant woman 10. The monitoring center 40 monitors the healthcare history of the pregnant woman 10 and reports the monitored results to the HIS 44. The HIS 44 provides the monitored results to a medical professional of the relevant hospital, and if any concerns are detected in the pregnant woman's 10 condition by the medical professional, notifies said pregnant woman of these concerns so that they may be dealt with.

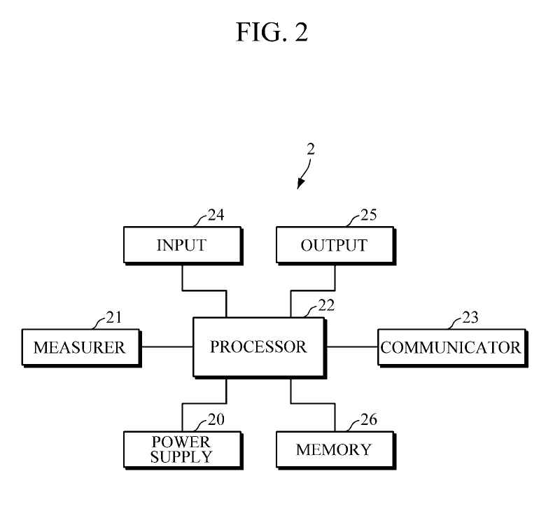

FIG. 2 is a diagram illustrating a PHD according to an exemplary embodiment.

Referring to FIGS. 1 and 2, a PHD 2 includes a power supply 20, a measurer 21, a processor 22, a communicator 23, an input 24, an output 25, and a memory 26.

The power supply 20 controls the power on/off status of the PHD 2. When power is supplied, the measurer 21 measures the health conditions of a pregnant woman so as to gather her personal health information. According to the PHD standards and the Bluetooth® HDPs, which are defined for each PHD, the processor 22 processes the personal health information, and controls the connection to the smart device 3, as well as the information transmission thereto or reception therefrom. For example, if the PHD 2 is a urine analyzer, the processor 22 controls the connection to the smart device 3 and the information transmission thereto or reception therefrom according to the IEEE 11073-10422 PHD standards. In another example, if the PHD 2 is a sphygmomanometer, the processor 22 controls the connection to the smart device 3 and the information transmission thereto or reception therefrom according to the IEEE 11073-10407 PHD standards.

The communicator 23 transmits the personal health information to the smart device 3 by using the PHD standards and the Bluetooth® HDPs. The personal health information may be transmitted to a server 4 through a PC, a gateway, and the smart device 3. The input 24 receives a user manipulation command, and the output 25 displays the gathered personal health information onto a screen. The personal health information output through the output 25 is transmitted to the smart device 3 via the communicator 23. In the memory 26, the program executed by the processor 22, the data required for the program execution, and the measurement result data are stored.

When the PHD 2 is a urine analyzer, to which the IEEE 11073-10422 PHD standards have been applied, the urine analyzer, via the measurer 21, gathers personal health information from the urine of the pregnant woman 10 with regard to the presence of bilirubin, glucose, ketones, leukocyte esterase, nitrite, pH, gravity, occult blood, protein, and urobilinogen. The personal health information that is acquired through urine would include any abnormal compounds secreted from a urinary system, and so using said information, a prognosis for the pregnant woman 10 can be made of seventy or more types of urologic diseases, such as nephritis, pyelonephritis, cystitis, kidney stones, prostatitis, etc.

Since the power supply 20 is made of Li-Polymer re-chargeable batteries, the power supply 20 is re-usable after being charged. When the pregnant woman 10 immerses a urine reagent strip in a sample of her urine, a high-luminance RGB LED is shone through said strip via ten channels using an optical splitting method; the measurer 21 then measures, with regard to the presence of the aforementioned compounds in the urine, the reflectometric degree of the immersed urine reagent strip. Here, the colors on the urine reagent strip are distinguished according to the HIS's comprehensive method, which distinguishes colors based on their hues, unclarity of the colors based on saturation, and color luminance based on brightness.

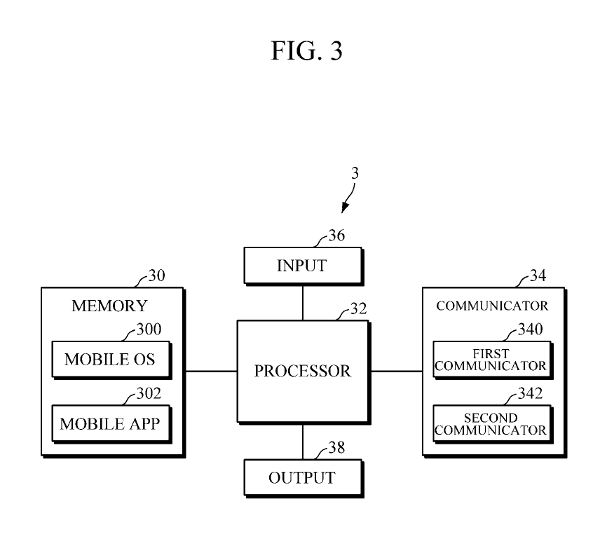

FIG. 3 is a diagram illustrating a smart device according to an exemplary embodiment.

Referring to FIGS. 1 and 3, a smart device 3 includes memory 30, a processor 32, a communicator 34, an input 36, and an output 38.

The memory 30 stores a mobile OS 300, e.g., Google's Android, Apple's iOS, Microsoft's Windows Mobile, etc., which is executable in the smart device 3. Also, the memory 30 includes a mobile app 302 that a pregnant woman 10 can run so that she may be provided with a pregnancy care service. The pregnant woman 10 runs the mobile app 302 and selects, through an input 36 by using a screen that is shown through the output 38, a PHD to which she wants to be connected. When the gathered personal health information is received from the PHD that is, according to the connection settings, connected by what is hereinafter referred to as first communicator′ 340, the output 38 displays the received personal health information onto the screen.

The processor 32 runs the mobile app 302 based on the mobile OS 300 and controls the connection to the PHD 2, in which PHD standards have been defined, as well as the data transmission thereto or reception therefrom. The communicator 34 includes the first communicator 340 and another communicator, hereinafter referred to as ‘second communicator’ 342. The first communicator 340 receives the personal health information via the PHD standards and the Bluetooth® HDPs from the PHD 2 to which it is connected. The second communicator 342 transmits the personal health information it has received through the first communicator 340 to the server 4, which provides pregnancy care services. The personal health information may include the urine analysis result that has been acquired by a urine analyzer, to which IEEE 11073-10422 PHD standards have been applied, along with the blood pressure data that has been acquired from a sphygmomanometer, to which IEEE 11073-10407 PHD standards have been applied.

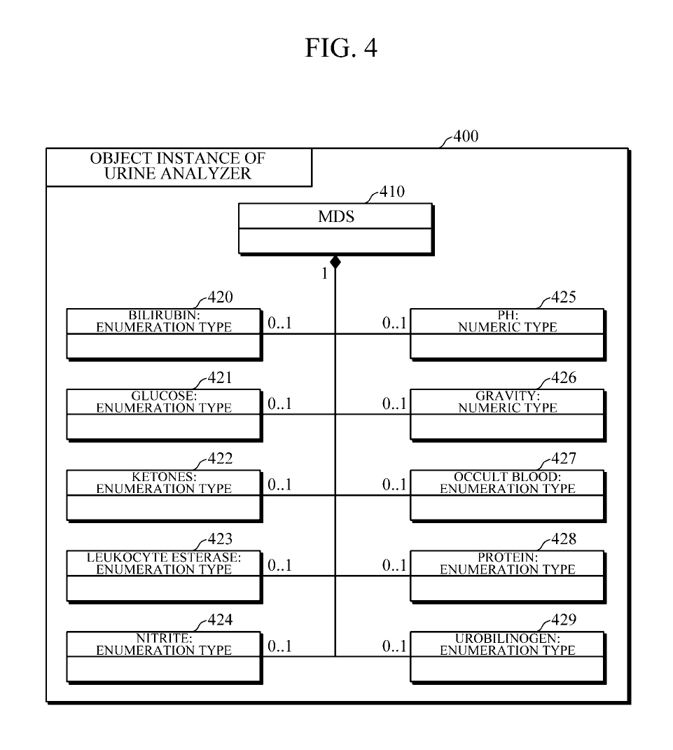

FIG. 4 is a diagram illustrating object instances of a urine analyzer according to an exemplary embodiment.

IEEE 11073-20601 standards support various types of PHDs, and define a data format and an exchange protocol between the PHD and a managing device so as to guarantee the data transmission reliability and the interoperability. The IEEE 11073-20601 standards are largely composed of a domain information model (hereinafter referred to as ‘DIM’), a service model, and a communication model. The DIM is an object-oriented model, which presents the PHD as one object set. Also, the DIM may select and compose the object to reflect the PHD's characteristics, and define the object's attributes, a usable method, event, service, etc.

Referring to FIG. 4, the DIM shows the biggest differences in their applications depending on the PHD's characteristics. The medical device system 410 (hereinafter referred to as ‘MDS’), which is the highest class, comprises various subordinate classes therein according to which data the relevant PHD processes. In a case in which the relevant PHD handles only numerical data, numeric classes 425 and 426 are used; and in a case in which the relevant PHD transmits additional information regarding various factors that may affect the measurement values, the device status, etc., enumeration classes 420, 421, 422, 423, 424, 427, 428, and 429 are added to its comprisal.

The object instances 400 of the urine analyzer has classes, their comprisals defined to have constitutions that include objects that send, to MDS 410, the measurement values of bilirubin 420, glucose 421, ketones 422, leukocyte esterase 423, nitrite acid 424, pH 425, gravity 426, occult blood 427, protein 428, and urobilinogen 429. Furthermore, captions next to the boxes that show the classes present the standard constitution as 1, and the additional constitution as 0 . . . 1.

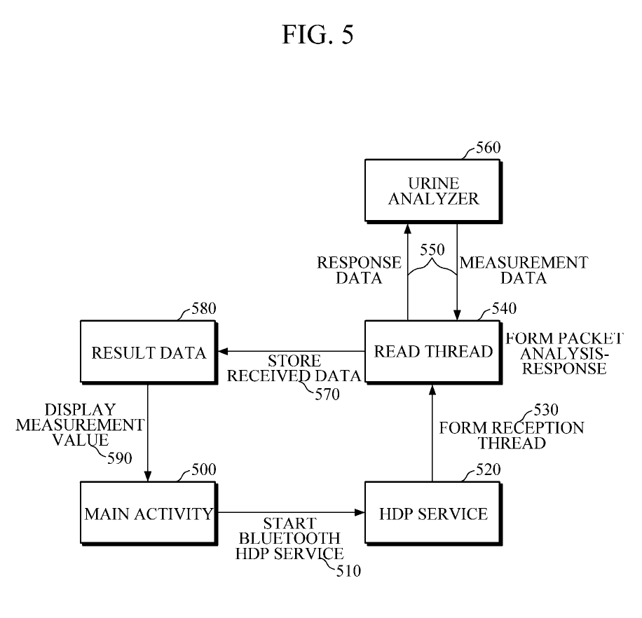

FIG. 5 is a flowchart illustrating a process for processing measurement information of a smart device according to an exemplary embodiment.

Referring to FIG. 5, a smart device starts a Bluetooth® HDP service in 510 and 520, forms a reception thread in 530, and transmits the response data to a read thread 540 and receives the measurement data from a PHD. This can be seen, for example, when measurement data is received from the urine analyzer 560, and then a response data is transmitted, all via an analysis-response composition as shown in 550. The smart device saves the received measurement data as result data 580 in 570 and displays the measurement data 590 onto a main activity screen 500 in 590.

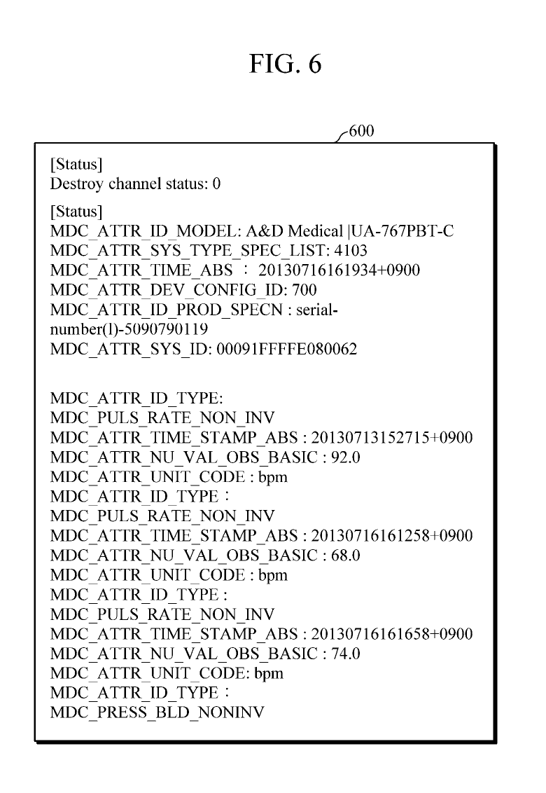

FIG. 6 is a diagram illustrating a screen onto which the data received from a PHD has been displayed by a smart device according to an exemplary embodiment.

Referring to FIG. 6, standard manager software is provided, which may test a protocol transmission of a PHD that follows IEEE 11073 PHD standards for the communications using IEEE 11073 PHD standards between the PHD and a smart device. The standard manager software provides the following: Bluetooth® HDPs; a user interface (UI) for communications, to which IEEE 11073 PHD standards have been applied, and its communications configuration; a log function; an external interface for connection to a mobile app of a smart device; a function for exchanging a signal with a mobile OS standard interface, and an application program interface (API).

The PHD transmits the measurement data to the smart device according to IEEE 11073 PHD standards, and the smart device parses the received measurement data to be displayed onto a screen 600 as illustrated in FIG. 6. Here, if the PHD's measurement data and the smart device's received measurement data are the same, this indicates that the data has been certainly transmitted to the smart device.

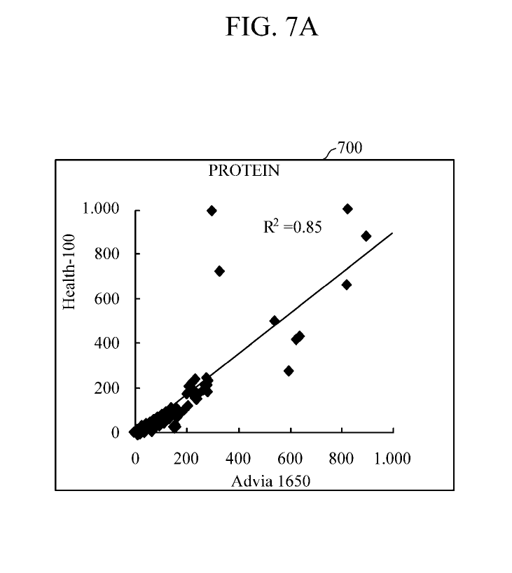

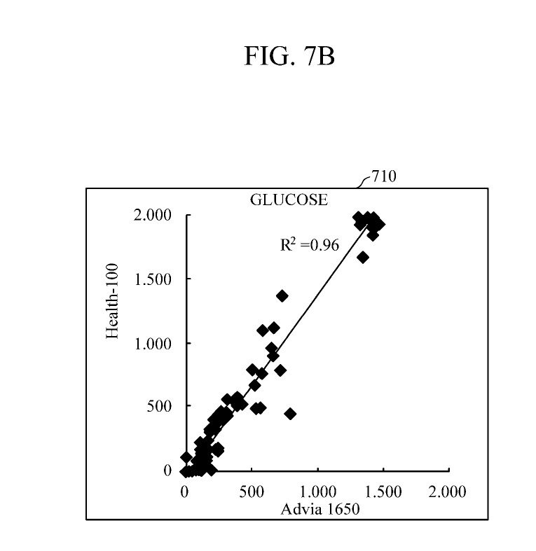

FIGS. 7A and 7B are diagrams illustrating a correlation between protein and glucose with regards to a urine analyzer and an ADVIA 1650 analyzer according to an exemplary embodiment.

Referring to FIGS. 7A and 7B, based on the comparison of measurement results between a urine analyzer and an existing ADVIA 1650 analyzer (Siemens Ltd.), the correlation coefficient R² of protein is 0.85 as illustrated in the numerical reference 700; and the correlation coefficient R² of glucose is 0.96 as illustrated in the numerical reference 710. Thus, it can be determined that the urine analyzer has a high correlation with the ADVIA 1650 analyzer.

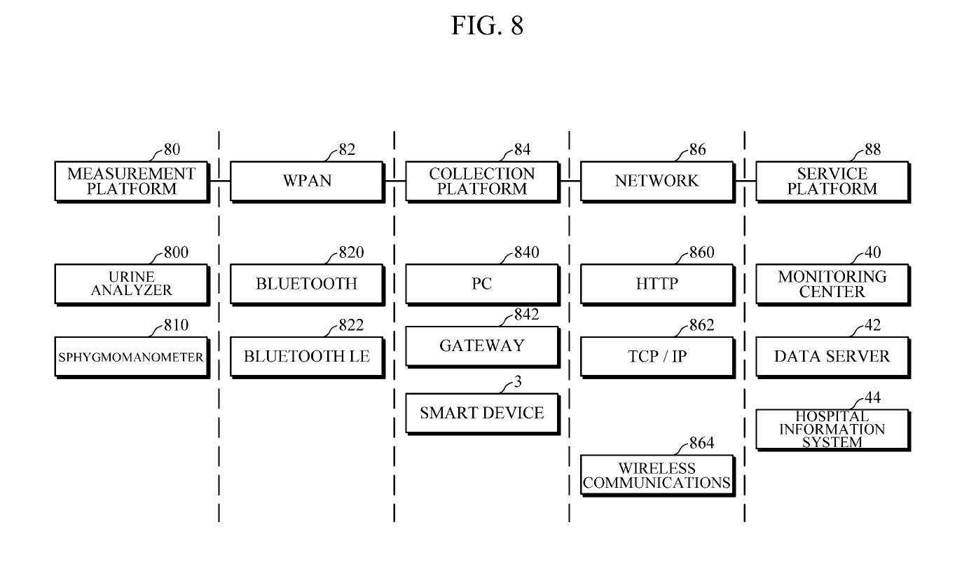

FIG. 8 is a diagram illustrating a platform environment for providing pregnancy care services according to an exemplary embodiment.

Referring to FIG. 8, a platform for providing pregnancy care services includes a measurement platform 80, a collection platform 84, and a service platform 88.

So as to measure the health conditions of pregnant women, the measurement platform 80 gathers her personal health information by using the PHD, which is an IT convergence device, such as a urine analyzer 800 and a sphygmomanometer 810. The collection platform 84 collects the personal health information, which has been measured from the measurement platform 80, through the same user access network as a wireless personal area network 82 (hereinafter referred to as ‘WPAN’). Wireless communication, e.g., a Bluetooth® 820, a Bluetooth® low energy (LE) 822, is made possible by using the WPAN 82. The collection platform 84 may include a PC 840, a gateway 842, and a smart device 3. The smart device 3 may transmit the personal health information to the service platform 88 through the gateway 842.

The collection platform 84 is connected to the service platform 88 through a network 86 and transmits the personal health information, collected from the measurement platform 80, to the service platform 88 also through the network 86. The service platform 88, which may include a monitoring center 40, a data server 42, and a HIS 44, operates, stores, and manages the collected information. The network 86 may use all usable wired and/or wireless communications, such as HTTP 860, TCP/IP 862, and wireless communications 864.

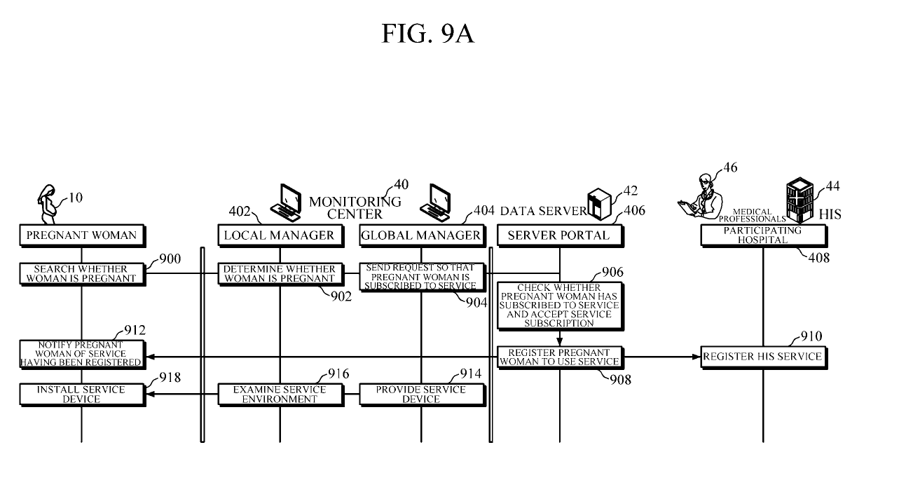

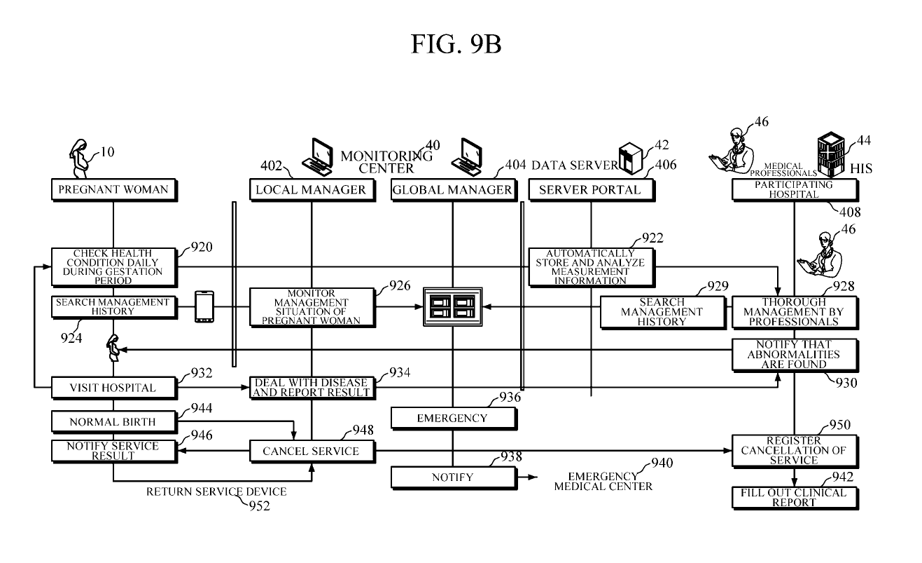

FIGS. 9A and 9B are flowcharts illustrating processes of pregnancy care services according to an exemplary embodiment.

Referring to FIGS. 9A and 9B, pregnancy care services are provided so as to manage the health conditions of both pregnant women and babies in utero for the duration of the entire gestation period by using the medical knowledge of medical professionals and the latest convergence technology of IT and medical technologies.

First, a search is carried out to determine whether a woman is pregnant as shown in 900. Then, a local manager 402 of a monitoring center 40 determines whether the woman is pregnant as shown in 902, and if it is determined that the woman is indeed pregnant, a global manager 404 of the monitoring center 40 sends, a request to a data server 42 so that the pregnant woman 10 is subscribed to the pregnancy care services as shown in 904. A server portal 406 of the data server 42 checks whether the pregnant woman 10 is subscribed to the service and accepts the service subscription of the pregnant woman 10 as shown in 906, registers the pregnant woman 10 so that she may use the service as shown in 908, and then registers the HIS service provided by a HIS 44 of a participating hospital 408 as shown in 910. The data server 42 notifies the pregnant woman 10 of the service having been registered as shown in 912. The subjects receiving the service may be selected by an in-hospital bioethics committee among patients visiting the hospital or residing outside the hospital. For example, the pregnant women at high risk, e.g., aged pregnant women, may be selected as the subjects. When the service registration is completed, the global manager 404 provides the pregnant woman 10 with devices for the service including a PHD as shown in 914; the local manager 402 examines the service environment to be provided to the pregnant woman 10 as shown in 916; and the pregnant woman 10 installs the service device as shown in 918.

The pregnant woman 10 may frequently measure her conditions and check her personal health information during her pregnancy using the installed devices to check her health conditions daily as shown in 920. The measurement information of the pregnant woman 10 is transmitted via a smart device to the data server 42, which then stores and analyzes the measurement information as shown in 922. The medical professionals 46 of the participating hospital 408 thoroughly manage the health conditions of the pregnant woman 10 by using the measurement information as shown in 928. Here, the medical professionals 46 may search the management history including the measurement information as shown in 929. The pregnant woman 10 may also search her management history as shown in 924. The local manager 402 of the monitoring center 40 may monitor the management of the pregnant woman 10 as shown in 926. If the medical professionals 46, while thoroughly managing her health as shown in 928, find any abnormalities, the medical professionals 46 notify the pregnant woman 10 as shown in 930. Said pregnant woman 10 may then visit the participating hospital 408 as shown in 932, so that the medical professionals 46 in the participating hospital 408 may treat her. The local manager 402 deals with the situation and reports it to the participating hospital 408 as shown in 934. If the pregnant woman 10 were to be in an emergency, the global manager 404 notifies an emergency medical center 940 of the emergency as shown in 938 so that the situation may be dealt with. The operation 920 of checking the health conditions of the pregnant woman 10 daily may be frequently performed throughout the gestation period until a normal birth 944.

Once the pregnant woman 10 has given birth as shown in 944, the local manager 402 cancels the service in 948; the participating hospital 408 registers the cancellation of the service as shown in 950; and the medical professionals 46 fill out a clinical report as shown in 942. The service cancellation is notified to the pregnant woman 10 as shown in 946. The pregnant woman 10 is to then return the service device as shown in 952.

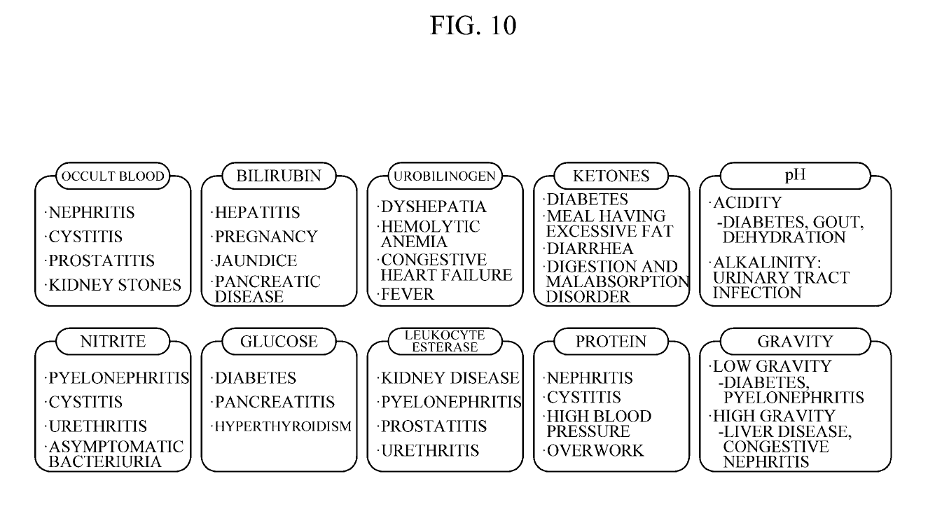

FIG. 10 is a diagram illustrating a list of diseases that may be discovered using a urine analyzer according to an exemplary embodiment.

According to health conditions of pregnant women being monitored and receiving consultation, the diseases of the pregnant women, as illustrated in FIG. 10, may be discovered by a urine analyzer. The urine analyzer may even prevent in advance risks such as pregnancy toxemia, abortion, and fetal deformity, may be also prevented in advance.

In one exemplary embodiment, while staying at home without actually going to or being admitted to a hospital, pregnant women may constantly monitor their health conditions with mobile IT convergence devices, such as a urine analyzer and a sphygmomanometer using IT technology. Also, pregnancy toxemia, abortion, fetal deformity, etc. may be prevented in advance. Furthermore, the present disclosure may be more efficiently used in promoting the convergence between IT and medical technologies, reducing the medical expenses, as well as in encouraging higher birthrates as a proactive response to the population decline.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A personal healthcare device (PHD), comprising:
a measurer configured to measure health conditions of a pregnant woman so as to gather personal health information from a pregnant woman;
a processor configured to, according to PHD standards defined for each PHD and Bluetooth healthcare device profiles for Bluetooth communications, process personal health information, and control a connection to a smart device, which is based on a mobile operating system (OS), as well as an information transmission thereto or reception therefrom; and
a communicator configured to transmit the personal health information to the smart device by using the PHD standards and the Bluetooth healthcare device profiles.

2. The PHD of claim 1, wherein the PHD is a urine analyzer, and the processor is configured to control the connection to the smart device and the information transmission thereto or reception therefrom according to IEEE 11073-10422 PHD standards.

3. The PHD of claim 1, wherein the PHD is a sphygmomanometer, and the processor is configured to control the connection to the smart device, as well as the information transmission thereto or reception therefrom according to IEEE 11073-10407 PHD standards.

4. The PHD of claim 1, wherein the processor is configured to analyze the personal health information by, based on hues, saturation, and brightness, distinguishing a color of a urine reagent strip, which is acquired by immersing the urine reagent strip in a sample of urine of the pregnant woman.

5. The PHD of claim 1, wherein the communicator is configured to test a transmission of a PHD standard protocol between the PHD and the smart device.

6. The PHD of claim 1, wherein the personal health information comprises measurement data including bilirubin, glucose, ketones, leukocyte esterase, nitrite, pH, gravity, occult blood, protein, urobilinogen.

7. The PHD of claim 1, wherein the personal health information is distinguished into at least one of numeric data shown in number, enumeration data showing events, and waveform data according to types of measurement data measured by the PHD.

8. A smart device, comprising:
a memory in which a mobile operating system (OS) is stored;
a processor configured to execute a mobile application based on a mobile OS and control a connection to a personal healthcare device (PHD), in which PHD standards are defined, as well as data transmission thereto or reception therefrom;
a first communicator configured to receive gathered personal health information from a pregnant woman through at least one PHD by using PHD standards and Bluetooth healthcare device profiles (HDPs); and
a second communicator configured to transmit, to a healthcare service server, which provides healthcare services for a pregnant woman (pregnancy care services), the personal health information received from the first communicator.

9. The smart device of claim 8, wherein the personal health information comprises a urine analysis result acquired by a urine analyzer, to which IEEE 11073-10422 PHD standards are applied.

10. The smart device of claim 8, wherein the personal health information comprises blood pressure data acquired from a sphygmomanometer, to which IEEE 11073-10407 PHD standards are applied.

11. A method of providing healthcare services for a pregnant woman (pregnancy care services), the method comprising:
measuring health conditions of a pregnant woman so as to gather personal health information of the pregnant woman through at least one PHD, where PHD standards are defined;
receiving, by a smart device based on a mobile OS, the personal health information from at least one PHD by using PHD standards and Bluetooth healthcare device profiles (HDPs);
transmitting, by the smart device, the personal health information to a server; and
managing, by the server, the health conditions of the pregnant woman through a service platform by using the personal health information.

12. The method of claim 11, wherein the receiving of the personal health information from the at least one PHD comprises:
executing a mobile application of the smart device;
displaying a list with at least one PHD that is connectable in response to the execution of the mobile application, receiving, from a user, a selection of the PHD to be connected, and setting a connection for a use of Bluetooth healthcare device profiles;
establishing a connection to the selected PHD; and
receiving the gathered personal health information from the connected PHD according to the PHD standards and the Bluetooth healthcare device profiles (HDPs).

13. The method of claim 11, wherein the service platform comprises a monitoring center, a data server, and a hospital information system (HIS); and
the managing of the health conditions of the pregnant woman comprises:
storing, at the data server, a healthcare history comprising the personal health information of the pregnant woman;
monitoring, by the monitoring center, the healthcare history of the pregnant woman and reporting the monitored results to the HIS; and
providing, by the HIS, the monitored results, and in response to a detection of any concerns of the pregnant woman's conditions, notifying the pregnant woman of the concerns.

14. The method of claim 11, wherein the managing of the health conditions of the pregnant woman comprises:
storing, by the server, the received personal health information, automatically analyzing the stored personal health information, and determining whether the pregnant woman has bad health conditions.

15. The method of claim 11, wherein the personal health information comprises:
a urine analysis result acquired by a urine analyzer, to which IEEE 11073-10422 PHD standards are applied; and
blood pressure data acquired from a sphygmomanometer, to which IEEE 11073-10407 PHD standards are applied.

16. The method of claim 11, wherein the managing of the health conditions of the pregnant woman comprises:
managing the health conditions of the pregnant woman by using a urine analysis result and blood pressure data, which are received from a urine analyzer and a sphygmomanometer through the smart device.

17. The method of claim 11, wherein the transmitting of the personal health information to the server comprises:
transmitting, by the smart device, the personal health information to a gateway; and
transmitting, by the gateway, the personal health information to the server.

18. The method of claim 11, wherein the service platform comprises a monitoring center, a data server, and a hospital information system (HIS); and
the method further comprises:
prior to a provision of pregnancy care services, determining, by the monitoring center, whether a woman is pregnant, and in response to the determination that the woman is indeed pregnant, sending a request to the data server so that the pregnant woman is subscribed to the pregnancy care services;
checking and accepting, by the data server, whether the pregnant woman is subscribed to the pregnancy care services, registering the pregnant woman so that the pregnant woman uses the pregnancy care services, and registering the healthcare service provided by a HIS of a participating hospital; and
in response to completion of the healthcare service registration, providing the pregnant woman with a device for the healthcare service including a PHD through the monitoring center.
